(19) United States
(12) Patent Application Publication
(10) Pub. No.: US 2015/0350539 A1
(43) Pub. Date: Dec. 3, 2015

(54) DEVICES AND METHODS OF INFORMATION-CAPTURE

(71) Applicant: Quanta Computer Inc., Taoyuan City (TW)

(72) Inventors: Chen-Hwa Sung, Taoyuan City (TW); Yung-Cheng Peng, Taoyuan City (TW); Tsung-Hsun Li, Taoyuan City (TW)

(21) Appl. No.: 14/591,272

(22) Filed: Jan. 7, 2015

(30) Foreign Application Priority Data
May 28, 2014 (TW) 103118537

(51) Int. Cl. H04N 5/232; G06T 11/60; G06F 21/10; G06K 9/52; G06F 17/30; G06K 9/46; G06T 7/20

(52) U.S. Cl. CPC H04N 5/23229; G06K 9/46; G06T 11/60; G06T 7/20; G06K 9/52; G06F 17/3028; G06F 21/10; G06K 2009/4666; G06F 2221/0724

(57) ABSTRACT

An information-capture device includes a video-capture device, a pre-processing module, an image-processing module, and a text generation module. The video capturing module is configured to capture a video data. The pre-processing module is configured to divide the video data into a background data and a foreground data. The image-processing module generates an object feature and the object-motion information according to the foreground data, and generates captured-space information of the video data according to the background data. The text generation module generates event-description information according to the object feature, the object-motion information, and the captured-space information, in which the event-description information is related to an event that occurred in the video data, including the information related to the event, and is a machine-readable text file.

### CROSS REFERENCE TO RELATED APPLICATIONS

This application claims priority of Taiwan Patent Application No. 103118537, filed on May 28, 2014, the entirety of which is incorporated by reference herein.

### BACKGROUND OF THE INVENTION

1. Field of the Invention

The disclosure relates generally to methods and devices for information capture, and more particularly it relates to methods and devices for transforming images into useful information.

2. Description of the Related Art

With the enhancing safety consciousness in the whole society, various imaging devices have become increasingly popular, and the quality of captured images is also getting better and better. However, this improvement in quality implies that the computing resources and the storage space required for handling and using these images are also increased rapidly. How to effectively handle and use these captured images is a problem that urgently needs to be solved.

Although current image-processing software is well-developed and able to automatically identify people and the objects in a picture, the computing resources required for processing a great quantity of image files are sometimes difficult to obtain. For example, when tracking a specific automobile by its license plates using a great number of monitoring cameras, images must be checked one by one by human operators and must take a lot of time. Therefore, we need a system that is able to effectively handle a great quantity of pictures to help us accomplish the tracking job.

### BRIEF SUMMARY OF THE INVENTION

For solving above problem, the invention provides an information-capture device and method for capturing the meaningful texts instead of a great number of images.

An embodiment of an information-capture device comprises a video-capture device, a pre-processing module, an image-processing module, and a text generation module. The video-capture device is configured to capture video data. The pre-processing module is configured to divide the video data into background data and foreground data. The image-processing module generates an object feature and object-motion information according to the foreground data, and generates captured-space information of the video data according to the background data. The text generation module generates event-description information according to the object feature, the object-motion information, and the captured-space information, wherein the event-description information is related to an event that occurred in the video data, and the event-description information comprises the information related to the event and is in the form of a machine-readable text file.

In an embodiment, the information-capture device further comprises a foreground image-processing module and a background image-processing module. The foreground image-processing module generates the object feature and the object-motion information according to the foreground data. The background image-processing module generates the captured-space information of the video data according to the background data.

In an embodiment, the foreground image-processing module comprises a feature-capture module, and a motion-detection module. The feature-capture module extracts the object feature according to the foreground data, and compares the object feature to a feature database to generate object information and feature information. The motion-detection module obtains moving behavior of the object according to an object movement algorithm and compares the moving behavior with a behavior database to generate behavior information, wherein the text generation module generates the event-description information according to the object information and the behavior information.

In an embodiment, the feature-capture module captures at least one critical point of the foreground data, generates a plurality of eigenvectors surrounding the center of the critical point, and generates the object information according to an object in the feature database having a minimum difference with the eigenvectors.

In an embodiment, the motion-detection module further generates a motion track according to the behavior information and the captured-space information, and the text generation module further generates the event-description information according to the motion track.

In an embodiment, the information-capture device further comprises an image-encryption module, a storage module, and a microprocessor. The image-encryption module encrypts the video to generate an encrypted image. The storage module stores the encrypted image. The microprocessor accesses the encrypted image according to the event-description information, and searches a corresponding section of the encrypted image according to the event-description information.

An embodiment of an information-capture method comprises capturing video data; dividing the video data into background data and foreground data; generating an object feature and object-motion information according to the foreground data; generating a captured-space information related to the video data according to the background data; and generating an event-description information according to the object feature, the object-motion information, and the captured-space information, wherein the event-description information is related to an occurred event of the video data, and the event-description information comprises the related information of the occurred event and is a machine-readable text file.

An embodiment of an information-capture method further comprises extracting the object feature according to the foreground data and comparing the object feature with a feature database to generate an object information; obtaining a moving behavior of the object according to an object movement algorithm and comparing the moving behavior with a behavior database to generate a behavior information; and generating the event-description information according to the object information, the feature description, and the behavior information.

In an embodiment of an information-capture method, further comprises capturing at least one critical point of the foreground data; generating a plurality of eigenvectors surrounding a center of the critical point; and generating the object information according to an object in the feature database having the minimum difference with the eigenvectors.

In an embodiment of an information-capture method, further comprises generating a motion track according to the behavior information and the captured-space information; and generating the event-description information according to the motion track.

In an embodiment of an information-capture method, further comprises encrypting the video data to generate an encrypted image; storing the encrypted image in a storage module; and accessing the encrypted image according to the event-description information and searching a corresponding section of the encrypted image according to the event-description information.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 is a block diagram of the information-capture device according to an embodiment of the invention;

FIG. 2 is a flow chart of the process for obtaining the object features according to an embodiment of the invention;

FIG. 3 is a flow chart of finding the critical points of the foreground data according to an embodiment of the invention;

FIG. 4 is a schematic of retrieving the critical points of the scale-space according to the embodiment of FIG. 3;

FIG. 5 is a schematic of rotating the critical points according to an embodiment of the invention;

FIGS. 6A-6D are schematics of the process of calculating eigenvalues according to an embodiment of the invention;

FIG. 7 is a flow chart of detecting motion according to an embodiment of the invention;

FIG. 8 is a block diagram of the image-access system according to another embodiment of the invention; and

FIG. 9 is a flow chart of the information-capture method according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

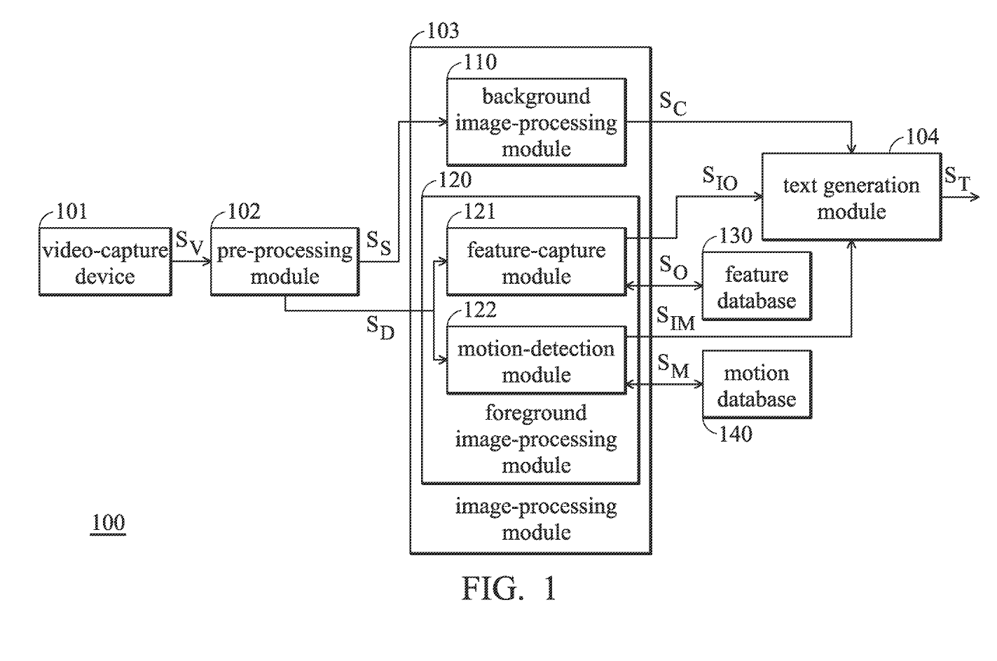

FIG. 1 is a block diagram of the information-capture device according to an embodiment of the invention. As shown in FIG. 1, the information-capture device 100 includes the video-capture device 101, the pre-processing module 102, the image-processing module 103, and the text generation module 104. The video-capture device 101 is configured to capture the video data S_{V} and transmits the video data S_{V} to the pre-processing module 102. After the pre-processing module 102 receives the video data S_{V}, the pre-processing module 102 divides the video data S_{V} into the background data S_{S} and the foreground data S_{D}, and transmits the background data S_{S} and the foreground data S_{D} to the image-processing module 103.

The image-processing module 103 includes the background image-processing module 110 and the foreground image-processing module 120. The background image-processing module 110 generates the captured-space information S_{C} of the video data S_{V} according to the background data S_{S}, and transmits the captured-space information S_{C} to the text generation module 104. According to another embodiment of the invention, the captured-space information S_{C} can be inserted by a user and stored in a storage device. The foreground image-processing module 120 generates the object feature S_{O} and the object-motion information S_{M} according to the foreground data S_{D}, and transmits the object feature S_{O} and the object-motion information S_{M} to the text generation module 104. According to an embodiment of the invention, the text generation module 104 generates the event-description information S_{T} related to the events that occurred in the video data S_{V}, according to the content of the captured-space information S_{C}, the object feature S_{O}, and the object-motion information S_{M} (not shown in FIG. 1).

According to an embodiment of the invention, the pre-processing module 102 takes the responsibility of capturing the foreground data S_{D} of the video data S_{V} and eliminating the duplicated pictures to reduce the size of the processed pictures. Since there is usually some duplicated information in the captured video, the computing load on the following devices can be released by this motion.

According to an embodiment of the invention, the event-description information S_{T} is a machine-readable text file, and the event-description information S_{T} includes the information of WHO, WHAT, WHEN, WHERE, and HOW related to the events that occurred according to the video data S_{V}. According to another embodiment of the invention, the event-description information S_{T} includes the information of any combination of WHO, WHAT, WHEN, WHERE, and HOW related to the events occurred in the video data S_{V}. According to an embodiment of the invention, the event-description information S_{T} is in json format; according to another embodiment of the invention, the event-description information S_{T} is in XML format.

As shown in FIG. 1, the foreground image-processing module 120 includes the feature-capture module 121 and the motion-detection module 122. The feature-capture module 121 extracts the object feature S_{O} according to the foreground data S_{D}, and compares the object feature S_{O} to the feature data of the feature database 130, in which the feature-capture module 121 chooses an object, which is the most similar to the object feature S_{O}, to generate the object information S_{IO}. The motion-detection module 122 obtains the object-motion information S_{M} of the object feature S_{O} according to an algorithm, and compares the object-motion information S_{M} with the moving behavior of the motion database 140 to generate the behavior information S_{IM}. According to another embodiment of the invention, the text generation module 104 generates the event-description information S_{T} according to the object information S_{IO} and the behavior information S_{IM}. The algorithm related to the feature-capture module 121 generating the object information S_{IO} and the motion-detection module 122 generating the behavior information S_{IM} will be described in detail below.

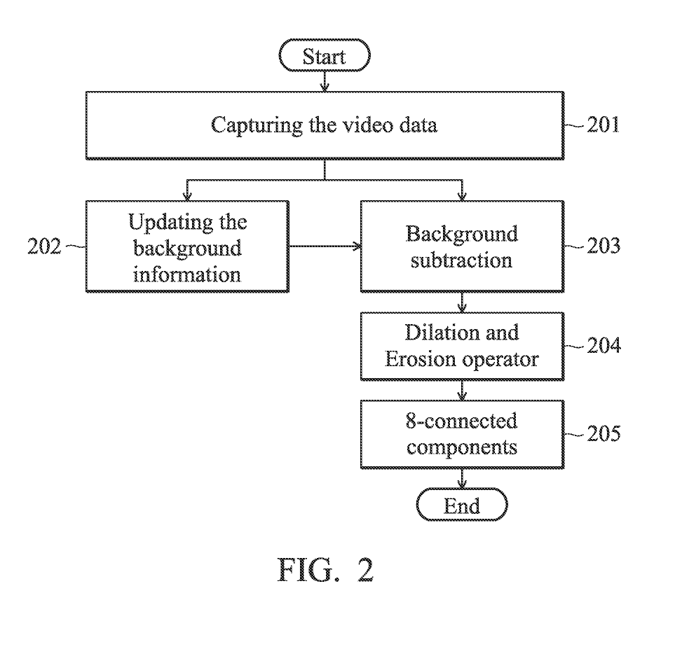

FIG. 2 is a flow chart of obtaining the object feature S_{O} according to an embodiment of the invention. As shown in FIG. 2, at the beginning, the video-capture device 101 of FIG. 1 is configured to capture the video data 201, and the pre-processing module 102 of FIG. 1 updates the background information 202 according to the probability of the picture changing. According to an embodiment of the invention, the background information is the background data S_{S} of FIG. 1. Then, the pre-processing module 102 subtracts the background information from the new picture by the background subtraction 203 to obtain the foreground data S_{D}, and enhances the foreground data S_{D} by the Dilation and Erosion operator 204. Finally, the pre-processing module 102 uses 8-connected components 205 to extract the foreground data S_{D} from the foreground information.

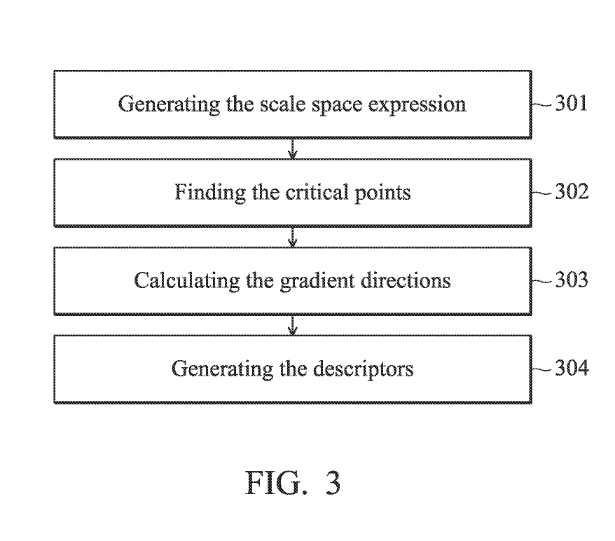

FIG. 3 is a flow chart of finding out the critical points of the foreground data S_{D} according to an embodiment of the invention. The algorithm for scale-invariant feature transform (SIFT), which is configured to find the critical points, is shown in the flow chart of FIG. 3. At the beginning, the feature-capture module 121 transforms the foreground data S_{D} obtained in FIG. 2 into the scale space expression (Step 301). Then, the critical points are found in the scale space (Step 302). According to the critical points found, the gradient directions of the critical points are calculated (Step 303). Finally, the descriptors of the critical points are generated according to the gradient directions of the critical points (Step 304). The process of generating the descriptors of the critical points will be described in detail below.

First, in Step 301, the feature-capture module 121 transforms the foreground data S_{D} into scale-space expression. That is, the image is convolved in different scales by the Gaussian filter and then down-sampled according to the given scale. According to an embodiment of the invention, the power of the Gaussian filter and the frequency of down-sampling are usually chosen to be a power of 2. That is, in each iteration, the image will be transformed into the images with different scales by the ratio of 0.5, and the images with different scales are convolved with a power of 2, by the Gaussian filter, to generate the scale space of the foreground information.

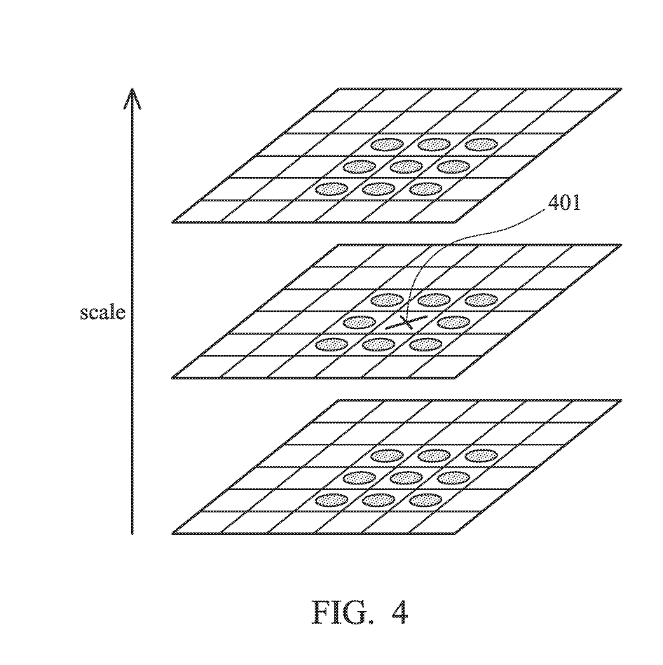

In Step 302, in order to find the critical points of the scale space, the critical points are then taken as maxima/minima of the Difference of Gaussians (DoG) that occur at multiple scales. FIG. 4 is a schematic of retrieving the critical points of the scale-space according to the embodiment of FIG. 3. As shown in FIG. 4, the middle critical point 401 is compared to the 8 adjacent points at the same scale and 9×2 points corresponding to the upper and lower scales, which are 26 points in total. A point, which is the maximum or the minimum among the 26 points at the present scale, upper scale, and lower scale, is determined as a critical point at the scale.

In Step 303, the main purpose is to unify the directions of the eigenvalues. In order to unify the directions of the eigenvalues, the algorithm of scale-invariant feature transform makes sure that each eigenvalue maintains its value even in different directions. The equations are listed as follows:

$$\begin{matrix}m ( x , y ) = \sqrt{{( L ( x + 1 , y ) - L ( x - 1 , y ) )}^{2} + {( L ( x , y + 1 ) - L ( x , y - 1 ) )}^{2}} & ( Eq . 1 ) \\ θ ( x , y ) = {tan}^{- 1} ( ( L ( x , y + 1 ) - L ( x , y - 1 ) ) / ( L ( x + 1 , y ) - L ( x - 1 , y ) ) ) & ( Eq . 2 )\end{matrix}$$

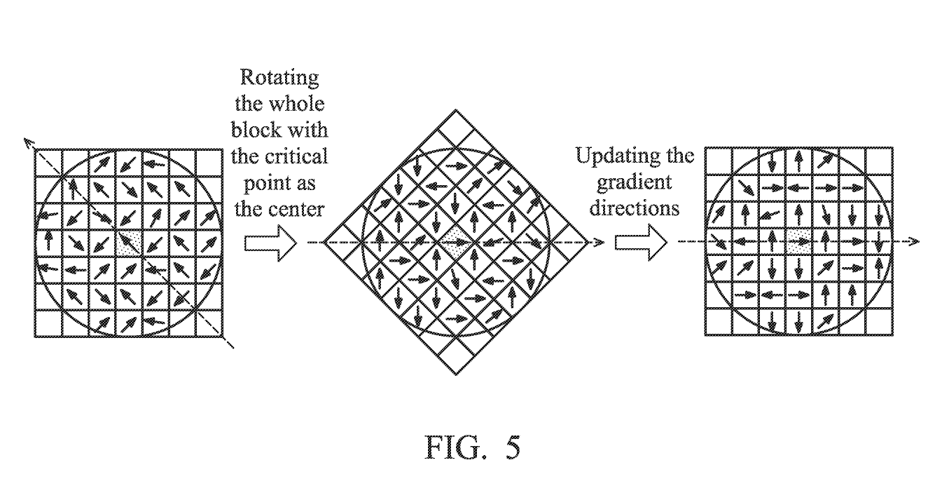

Eq. 1 is used to calculate the gradient amplitude of the critical points, and Eq. 2 is used to calculate the gradient direction of the critical points, in which L(x,y) is the grey-scale value of the display pixel. FIG. 5 is a schematic of rotating the critical points according to an embodiment of the invention. After obtaining the gradient direction of the critical points, as shown in FIG. 5, the critical point is as the center of the whole block, and the 8×8 sub-blocks surrounding the critical point are rotated to the gradient direction for the convenience of the calculation in the next step.

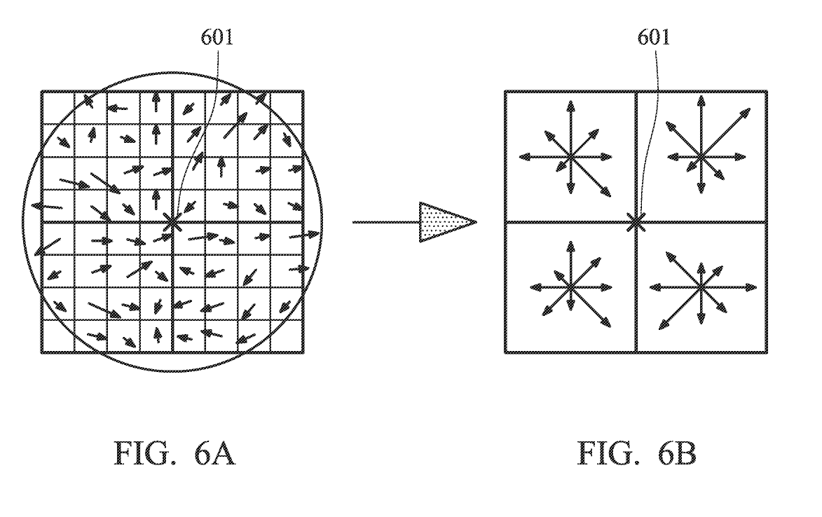

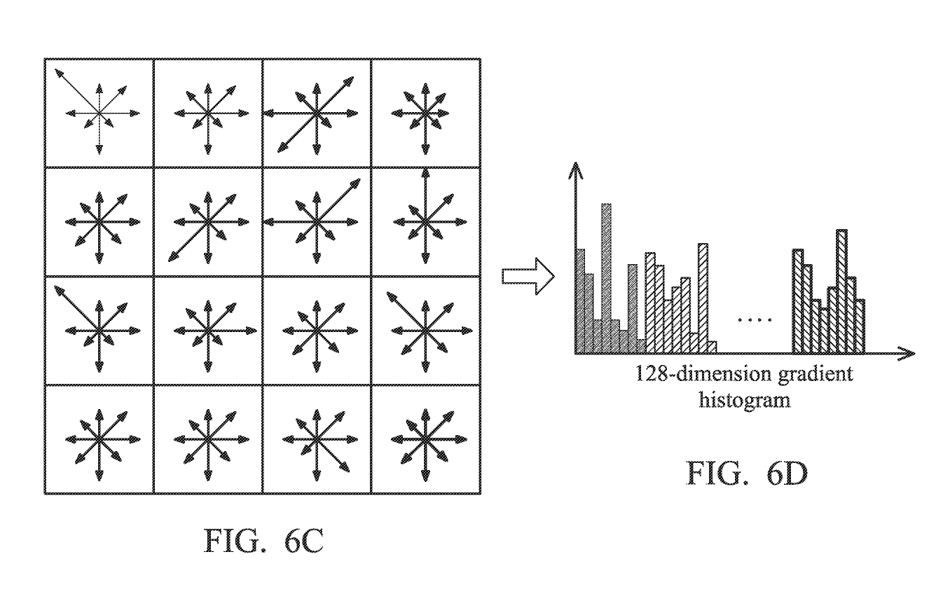

After unifying the directions of the critical points, Step 304 is executed to calculate the descriptors of the eigenvalues. FIGS. 6A-6D are schematics of the flow of calculating eigenvalues according to an embodiment of the invention. As shown in FIG. 6A, the whole block, which includes the 16×16 sub-blocks surrounding the critical point 601 as the center, has been rotated to the gradient direction. After unifying the direction, it starts to calculate the descriptors of the eigenvalues. As shown in FIG. 6B, the 16×16 sub-blocks surrounding the critical point 601 as the center are converted to a histogram based on the gradient directions, and the histogram is normalized to 8 directions, that is, 45 degrees as a unit. Taking FIG. 6B as an example, it is a plot of 2×2 gradient directions with 8×8 as a block.

As shown in FIG. 6C, four of the blocks shown in FIG. 6B are counted to form a plot of 4×4 gradient directions, and the amplitude of each gradient direction is converted into the 128-dimension gradient histogram shown in FIG. 6D. In order to eliminate the influence of illumination to the eigenvalues, the 128-dimension gradient histogram shown in FIG. 6D is normalized and the data of each histogram is collected to obtain the eigenvalues of scale-invariant feature transform. Then, some critical points are obtained in the object feature S_{O}, and each critical point has a 128-dimension descriptor. The feature-capture module 121 compares the 128-dimension descriptor to that in the feature database 130, and finds out the most similar object using Eq. 3.

$$d ( x , y ) = ‖ x - y ‖ = \sqrt{{\sum }_{i = 1}^{n} {( {x}_{i} - y )}^{2}} \qquad ( Eq . 3 )$$

In other words, the Euclidean distance is used to find the object, whose vector difference to the 128-dimension descriptor is the minimum, in the feature database 130, and the object is thus the most similar object. The feature-capture module 121 of FIG. 1 therefore generates the object information S_{IO} of the object feature S_{O} according to the most similar object in the feature database 130.

Regarding the found object feature S_{O} mentioned above, for a continuously changing object feature S_{O}, we continuously record the time of variance of each display pixel within the display block displaying the object feature S_{O}. Then, we extract the gradient direction of the time of variance to get the movement direction of the foreground block in the picture.

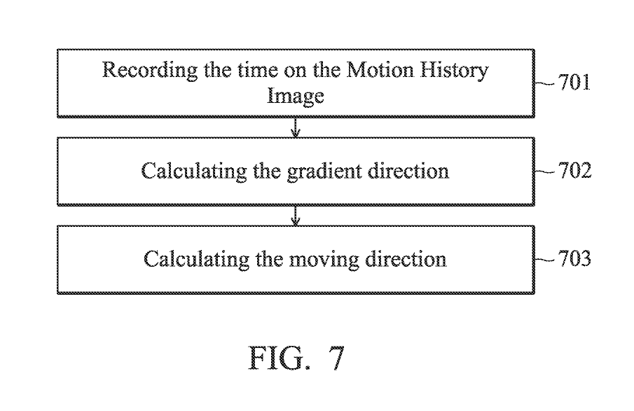

FIG. 7 is a flow chart of detecting motions according to an embodiment of the invention. As shown in FIG. 7, the claimed 2-dimension memory space is corresponding to the whole image at the beginning, which is named as Motion History Image (MHI) (step 701), in which the Motion History Image has the motion track of the foreground data, and the time recorded right at the movement on the motion track. According to an embodiment of the invention, the time it takes for the movement to happen is in nanosecond.

Then, on the whole Motion History Image, the X-direction and the Y-direction of the gradient direction are calculated according to the recorded position and the moving time respectively (Step 701), so that the X-axis and Y-axis of the moving speed are obtained. Finally, the moving direction of the foreground data S_{D} of the image is calculated by the trigonometric function (step 703), and the motion track is obtain by collecting a series of the motion-direction information. After that, the motion-detection module 122 records the moving direction and the motion track in the object-motion information S_{M}, compares the motion track of the object-motion information S_{M} with the moving behavior of the motion database 140, and the moving direction and the actual speed can be obtained with the aid of the captured-space information S_{C}. the motion-detection module 122 records the related information, such as the moving direction and the speed, in the behavior information S_{IM}.

The text generation module 104, according to the content of the captured-space information S_{C}, the object feature S_{O}, and the object-motion information S_{M}, generates the event-description information S_{T} related to the events occurred in the video data S_{V}. According to an embodiment of the invention, the event-description information S_{T} is in json format. According to another embodiment of the invention, the event-description information S_{T} is in XML format. According to an embodiment of the invention, the motion-detection module 122 is able to detect the moving behavior of the motion database 140 defined by another user, and it is only used for illustrating the detecting method of the invention herein, but not in any way to limit the moving behavior to the movement.

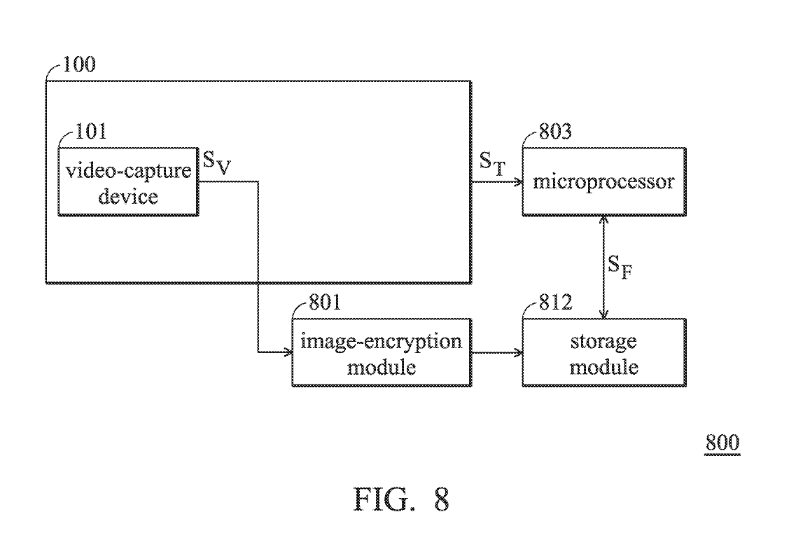

FIG. 8 is a block diagram of the image-access system according to another embodiment of the invention. As shown in FIG. 8, the image-access system 800 includes the information-capture device 100, the image-encryption module 801, the storage module 812, and the microprocessor 803. After the video-capture device 101 of the information-capture device 100 captures the image data S_{V}, the image data S_{V} is transmitted to the image-encryption module 801 for encryption and stored in the storage module 812. The microprocessor 803 accesses the image section S_{F} corresponding to the encrypted image data S_{V} stored in the storage module 812 according to the event-description information S_{T} generated by the data-capture device 100.

Since the encrypted video data S_{V} stored in the storage module 802 may be quite large, it needs to be searched by human operators when searching a specified section according to some event that was occurred. The searching time and the cost could be greatly reduced if we retrieve the event of the event-description information S_{T} generated by the data-capture device 100 and then access the corresponding section according to the time marker recorded in the event-description information S_{T}.

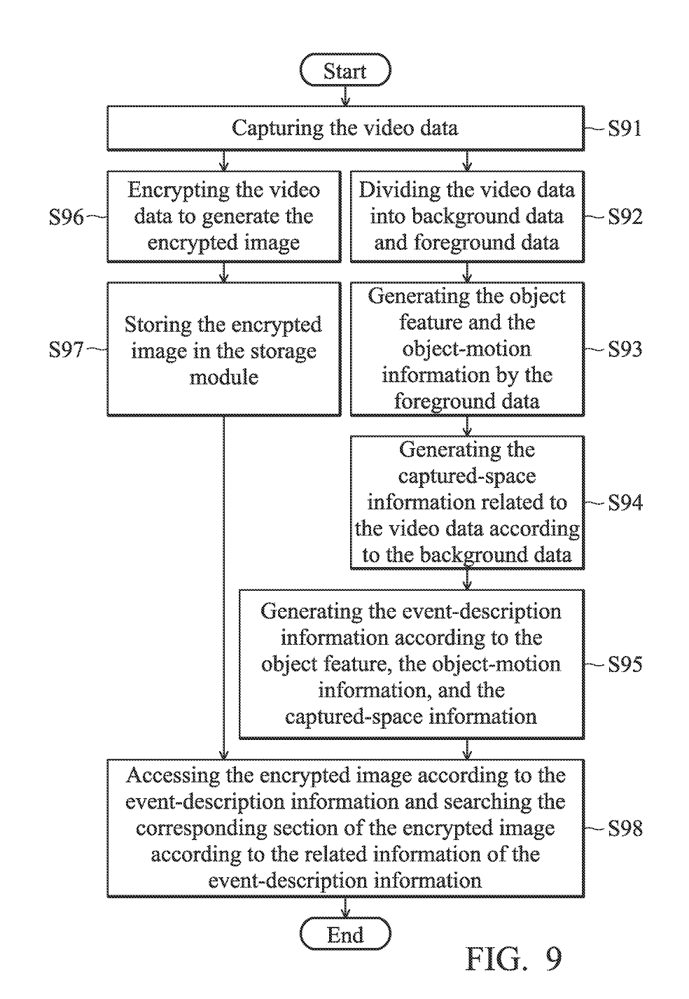

FIG. 9 is a flow chart of the information-capture method according to an embodiment of the invention. As shown in FIG. 9, the video data is captured at the beginning (Step S91); then, the video data is divided into background data and foreground data (Step S92). According to the foreground data, the object feature and the object-motion information are generated (Step S93). According to the background data, the captured-space information related to the video data is generated (Step S94). According to the object feature, the object-motion information, and the captured-space information, the event-description information is generated (Step S95), in which the event-description is related to the events that was occurred in the video data. The event-description information includes the related information of the event, and the event-description information is in machine-readable text.

Back to Step S91, after capturing the video data, the method includes encrypting the video data to generate the encrypted image (Step S96); storing the encrypted image in the storage module (Step S97); accessing the encrypted image according to the event-description information generated in Step S95 and searching the corresponding section of the encrypted image according to the related information of the event-description information (Step S98).

According to an embodiment of the invention, the device and method for information-capture disclosed in the invention can be adapted to a great quantity of monitoring cameras to search a specific automobile by its license plates. The computer generates the event-description information S_{T} according to the information-capture device 100, and finds which camera a car with the specific plate appears on in a very short period, or the computer can easily find out a car with the specific plate from which camera to another according to the event-description information S_{T}. The handling time and cost can be greatly reduced compared to manually filtering the monitoring screen as the prior art or tracking vehicles by human resources.

According to another embodiment of the invention, the invention can be adapted to a great quantity of monitoring cameras, such as those used by the Taipei Metropolitan Rapid Transit System. As long as the administrator is aware of the population being rapidly growing, the administrator can do some proper reactions for the rapid-growth population. For example, the information-capture device 100 may generate event-description information S_{T} having the number of people in the video data S_{V} according to the video data S_{V} captured by the video-capture device 101. The administrator can be aware of the change of the population immediately, according to the number of people of the event-description information S_{T}, to make the best decision in advance.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. An information-capture device, comprising:
a video-capture device, configured to capture video data;
a pre-processing module, configured to divide the video data into background data and foreground data;
an image-processing module, generating an object feature and object-motion information according to the foreground data, and generating captured-space information for the video data according to the background data; and
a text generation module, generating event-description information according to the object feature, the object-motion information, and the captured-space information, wherein the event-description information is related to an event that occurred in the video data, and the event-description information comprises the information related to the event and is in the form of a machine-readable text file.

2. The information-capture device of claim 1, wherein the image-processing module further comprises:
a foreground image-processing module, generating the object feature and the object-motion information according to the foreground data; and
a background image-processing module, generating the captured-space information of the video data according to the background data.

3. The information-capture device of claim 2, wherein the foreground image-processing module comprises:
a feature-capture module, extracting the object feature according to the foreground data, and comparing the object feature to a feature database to generate object information and feature information; and
a motion-detection module, obtaining moving behavior of the object according to an object movement algorithm, and comparing the moving behavior with a behavior database to generate behavior information, wherein the text generation module generates the event-description information according to the object information and the behavior information.

4. The information-capture device of claim 3, wherein the feature-capture module captures at least one critical point of the foreground data, generates a plurality of eigenvectors surrounding a center of the critical point, and generates the object information according to an object in the feature database having a minimum difference with the eigenvectors.

5. The information-capture device of claim 3, wherein the motion-detection module further generates a motion track according to the behavior information and the captured-space information, and the text generation module further generates the event-description information according to the motion track.

6. The information-capture device of claim 1, further comprising:
an image-encryption module, encrypting the video to generate an encrypted image;
a storage module, storing the encrypted image; and
a microprocessor, accessing the encrypted image according to the event-description information and searching a corresponding section of the encrypted image according to the event-description information.

7. An information-capture method, comprising:
capturing a video data;
dividing the video data into a background data and a foreground data;
generating an object feature and an object-motion information according to the foreground data;
generating a captured-space information related to the video data according to the background data; and
generating an event-description information according to the object feature, the object-motion information, and the captured-space information, wherein the event-description information is related to an occurred event of the video data, and the event-description information comprises the related information of the occurred event and is a machine-readable text file.

8. The information-capture method of claim 7, further comprising:
extracting the object feature according to the foreground data and comparing the object feature with a feature database to generate an object information;
obtaining a moving behavior of the object according to an object movement algorithm and comparing the moving behavior with a behavior database to generate a behavior information; and
generating the event-description information according to the object information, the feature description, and the behavior information.

9. The information-capture method of claim 8, further comprising:
capturing at least one critical point of the foreground data;
generating a plurality of eigenvectors surrounding a center of the critical point; and
generating the object information according to an object in the feature database having the minimum difference with the eigenvectors.

10. The information-capture method of claim 8, further comprising:
generating a motion track according to the behavior information and the captured-space information; and
generating the event-description information according to the motion track.

11. The information-capture method of claim 7, further comprising:
encrypting the video data to generate an encrypted image;
storing the encrypted image in a storage module; and
accessing the encrypted image according to the event-description information and searching a corresponding section of the encrypted image according to the event-description information.
